(19) United States
(12) Patent Application Publication
(10) Pub. No.: US 2003/0236334 A1
(43) Pub. Date: Dec. 25, 2003

(54) Glueable polypropylene coated ream wrap

(76) Inventors: Steven J. Gatewood, Green Bay, WI (US); William J. Culhane, Wyoming, OH (US)

Correspondence Address: HOFFMAN, WASSON & GITLER, P.C., Suite 522, 2361 Jefferson Davis Highway, Arlington, VA, 22202, US

(21) Appl. No.: 10/426,960

(22) Filed: May 1, 2003

Related U.S. Application Data
(60) Provisional application No. 60/376,567, filed on May 1, 2002.

(51) Int. Cl. C08K 5/04; C08L 23/00

(52) U.S. Cl. 524/396; 525/240

(57) ABSTRACT

An extrudable polypropylene blend combined with resins in precise amounts so that the resultant extruded film is easier to glue and is useable with hot melt adhesives. Mixtures of polypropylene and low density polyethylene are normally considered incompatible, but the contemplated blends which include 10-30% low-density polyethylene mixed with polypropylene give resin combinations runnable on a coater extruder and they produce a film having the advantages of polypropylene but which are no more difficult to glue than a film of low-density polyethylene.

### BACKGROUND OF THE INVENTION

Sheets of paper are packaged, shipped and sold in ream size. Reamed paper is wrapped individually. The ream wrap must provide a good moisture paper barrier, have rip resistance when dropped, be glueable with hot melt glue, look attractive and be inexpensive. Virtually all extrusion coated ream wrap currently uses low density polyethylene (LDPE) to provide a moisture barrier. Polypropylene is a better choice for a moisture barrier except that its high surface tension makes it difficult to glue. Polypropylene has many advantages over polyethylene including a better moisture barrier, keeping the wrapped ream at uniform moisture and reducing curl of the product. Polypropylene is also glossier than polyethylene so ream wrap having a layer of polypropylene is more attractive. This increases the appeal at point of purchase. Polypropylene also has more tensile strength than LDPE, increasing tear resistance. The one feature of polypropylene preventing its use as a ream wrap is its incompatibility with hot melt adhesive.

### SUMMARY OF THE INVENTION

Polypropylene blended with several resins, in particular amounts, results in an extruded film which is easier to glue and usable with hot melt adhesive. One such resin is LDPE. Mixtures of polypropylene and LPDE are normally considered incompatible, but blends of 10-30% LDPE mixed with polypropylene give resin combinations runnable on a coater extruder and producing a film having the advantages of polypropylene but no more difficult to glue than a film of LDPE. Metallocene can be added to LDPE to provide better results. A blend of PP:LDPE:Metallocene in the ratio of 80:10:10 has been identified as producing advantageous results.

Other resin combinations have been successfully used as a ream wrap. These resin combinations can be extruded and sealed with a hot melt adhesive. Such resin combinations include 90% polypropylene and 10% C-5 resin such as mixed alkylated cycloaliphatic hydrocarbons, specifically Eastotac H-130E available from Eastman Chemicals and a 90% polypropylene:10% terpene resin, specifically Silvarez 7115 available from Arizona Chemicals.

### DETAILED DESCRIPTION OF THE INVENTION

Polypropylene is mixed with a number of different resins to allow the polypropylene to be extruded into film and used as a wrap. When polypropylene is mixed with these resins, the resulting film can be glued using a hot melt adhesive. The film has superior characteristics when used with the hot melt adhesive allowing the film to take advantage of the benefits of polypropylene.

Polypropylene is blended with 10-30% low density polyethylene (LDPE) providing a mixture that is extrudable into a film. The resulting film has the advantages of the increased moisture barrier of polypropylene as opposed to polyethylene, greater tensile strength resulting in increased tear resistance and a glossier finish and clarity of the resin, enhancing the printed paper ream wrap. The preferred embodiment of the polymer mixture is 80% polypropylene, 10% low density polyethylene and 10% metallocene. This mixture is extrudable into a film and has an affinity to hot melt glue adhesives allowing the film to be used as a ream wrap.

The increased barrier protection provided by polypropylene obviates the need for generic low density polyethylene moisture barrier on the inside of the package. The mixed resin film of the invention has no possibility of ink rub preventing transfer of colors from the ream wrap to package conveying systems, other packages of wrap and user's clothing.

Other resin blends have been successfully manufactured to combine the tear resistance and moisture barrier of polypropylene without the problems of hot melt affinity to polypropylene. Other resin combinations include a blend of 90% polypropylene and 10% C-5 resins. The C-5 resins are mixed and alkylated cycloaliphatic hydrocarbons, specifically Eastotac H-130E available from Eastman Chemicals. Yet another resin combination includes a 90% polypropylene and 10% terpene resin mix or blend. The terpene resin, specifically Silvarez 7115, is available from Arizona Chemicals. Blends of polypropylene with 10-30% LDPE have resulted in a film that is usable as a ream wrap.

The blends of the invention are useable as a ream wrap due to their ability to accept hot melt adhesives. This ability to accept hot melt adhesives does not hinder the polypropylene's superior characteristics of tear resistance and moisture barrier which are advantageous in a ream wrap.

What is claimed is:

1. An extrudable polypropylene blend composition comprising from 70-90% polypropylene and 10-30% polyethylene.

2. The polypropylene blend composition further comprising 10% metallocene.

3. The polypropylene blend composition as claimed in claim 1 wherein the polypropylene blend is 80% polypropylene, 10% 10% low density polyethylene and 10% metallocene.

4. A polypropylene blend composition comprising 90% polypropylene and 10% C5 resins.

5. The polypropylene blend composition as claimed in claim 4 wherein the C5 resins are mixed and alkylated cycloaliphatic hydrocarbons.
